(19) United States
(12) Patent Application Publication
(10) Pub. No.: US 2011/0048324 A1
(43) Pub. Date: Mar. 3, 2011

(54) IMAGE RECORDING APPARATUS

(75) Inventors: Kunichi YAMASHITA, Kanagawa (JP); Satoshi MOHRI, Kanagawa (JP); Masatoshi ARAKI, Kanagawa (JP); Hiroshi IKEDA, Kanagawa (JP)

(73) Assignee: FUJI XEROX CO., LTD., Tokyo (JP)

(21) Appl. No.: 12/728,370

(22) Filed: Mar. 22, 2010

(30) Foreign Application Priority Data
Aug. 27, 2009 (JP) 2009-196943

(51) Int. Cl. B05C 9/12

(52) U.S. Cl. 118/620; 118/600

(57) ABSTRACT

An image recording apparatus includes: a curable solution layer forming device that forms a curable solution layer by supplying a curable solution to a recording member or an intermediate member, the curable solution including at least a curable material to be cured by an external stimulus, and a water-absorbing component; an ink applying device that applies an ink to the curable solution layer; a stimulus supplying device that supplies the stimulus for curing the curable solution layer, to the curable solution layer; and a water-absorption controlling component-contact device that brings a liquid, including a component that controls water-absorption by the water-absorbing component, into contact with the curable solution layer, before or after the ink is applied to the curable solution layer by the ink applying device.

### CROSS-REFERENCE TO RELATED APPLICATION

This application is based on and claims priority under 35 USC 119 from Japanese Patent Application No. 2009-196943 filed on Aug. 27, 2009.

### BACKGROUND

1. Technical Field

The present invention relates to an image recording apparatus.

2. Related Art

For example, there is proposed a recording method in which a layer of powder capable of being dissolved or swelled in a liquid in dropwise form (a liquid droplet), capable of increasing the viscosity of the liquid and being strippable from an intermediate transfer body, is formed beforehand on the surface of an intermediate transfer body. Thereafter, an image in accordance with an image signal is formed on the intermediate transfer body by applying the liquid to the powder, and subsequently, the image formed on the intermediate transfer body is transferred onto a recording medium, wherein the powder to be coated on the intermediate transfer body contains a material that forms in a water-insoluble form when the powder comes into contact with an ink composition.

### SUMMARY

According to an aspect of the invention, there is provided an image recording apparatus including:

a curable solution layer forming device that forms a curable solution layer by supplying a curable solution to a recording member or an intermediate member, the curable solution including at least a curable material to be cured by an external stimulus, and a water-absorbing component;

an ink applying device that applies an ink to the curable solution layer;

a stimulus supplying device that supplies the stimulus for curing the curable solution layer, to the curable solution layer; and

a water-absorption controlling component-contact device that brings a liquid, including a component that controls water-absorption by the water-absorbing component, into contact with the curable solution layer, before or after the ink is applied to the curable solution layer by the ink applying device.

### BRIEF DESCRIPTION OF THE DRAWINGS

Exemplary embodiments of the present invention will be described in detail based on the following figures, wherein;

FIG. 1 is a configurational drawing showing an image recording apparatus according to a first exemplary embodiment;

FIG. 2 is a configurational drawing showing an image recording apparatus according to a second exemplary embodiment;

FIG. 3 is a configurational drawing showing an image recording apparatus according to a third exemplary embodiment; and

FIG. 4 is a configurational drawing showing an image recording apparatus according to a fourth exemplary embodiment.

### DETAILED DESCRIPTION

According to an exemplary embodiment of the invention, there is provided an image recording apparatus which suppresses image deformation after recording an image as compared with a case where a method, in which a component that controls water-absorption by a water-absorbing component is not brought into contact with the curable solution layer, is used.

Hereinafter, exemplary embodiments as an example of the present invention will be described in detail.

Hereinafter, the exemplary embodiments of the invention will be explained with reference to the drawings. The same denotations are assigned to the members having substantially the same functions through all the drawings, and overlapping explanations thereof may be omitted.

### First Exemplary Embodiment

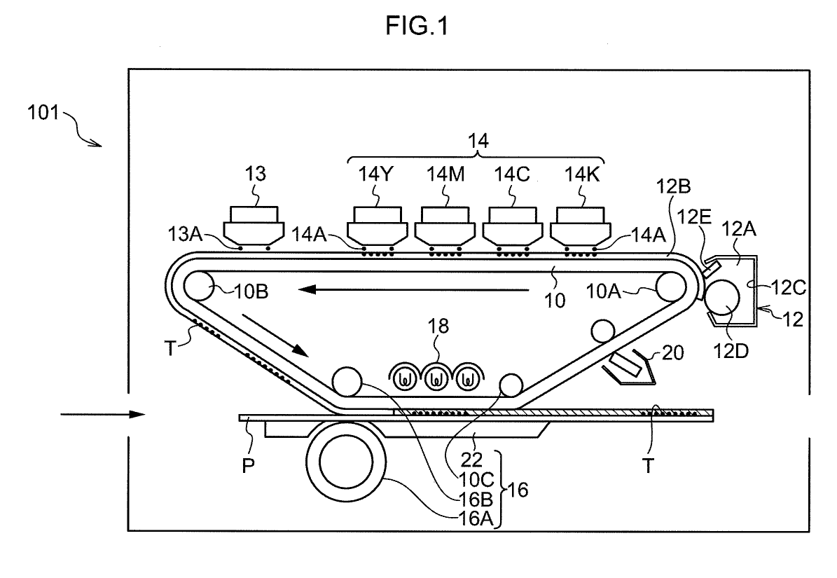

FIG. 1 is a configurational drawing showing an image recording apparatus according to a first exemplary embodiment of the invention.

An image recording apparatus 101 according to the first exemplary embodiment, as shown in FIG. 1, for example, is equipped with an endless-shaped intermediate transfer belt 10 (an example of an intermediate transfer body as a recording member), and on the periphery of the intermediate transfer belt 10, a curable solution layer forming device 12 (an example of a curable solution layer forming device) that supplies a curable solution 12A containing a curable material and a water-absorbing component therein to form a curable solution layer 12B; an inkjet recording head 14 (an example of an ink applying device) that forms an image T by applying an ink 14A to the curable solution layer 12B; a water-absorption controlling liquid supply device 13 (an example of a water-absorption controlling component-contact device) that supplies a liquid 13A (hereinafter, referred to as a water-absorption controlling liquid 13A) containing a component that controls the water-absorption by a water-absorbing component to the curable solution layer 12B at which the image T is formed; a transfer device 16 (an example of a transfer device) that transfers the curable solution layer 12B, at which the image T is formed, to a recording medium P by bringing the curable solution layer 12B, at which the image T is formed and the water-absorbing component is supplied, into contact with the recording medium P and by applying a pressure thereto; and a cleaning device 20 that removes residue of the curable solution layer 12B remaining on the surface of the intermediate transfer belt 10 or foreign matter (powder of recording paper and the like) adhered to the surface of the intermediate transfer belt 10, are provided on the intermediate transfer belt 10 in the moving direction (i.e., the direction of the arrow shown in FIG. 1) in sequence from the upstream side of the intermediate transfer belt 10.

Further, for example, a stimulus supplying device 18 that supplies a stimulus for curing the curable solution layer 12B while bringing the curable solution layer 12B into contact with the recording medium P is arranged at the inside of the intermediate transfer belt 10. That is, the stimulus supplying device 18 is arranged so as to face the region where the curable solution layer 12B is in contact with the recording medium P.

The intermediate transfer belt 10 is arranged, for example, such that the intermediate transfer belt 10 is tensed and rotatably supported by three support rolls 10A, 10B and 10C, and a pressure roll 16B (included in the transfer device 16) from the inside of the intermediate transfer belt 10. Further, the intermediate transfer belt 10 has a width (the length in the axial direction) equivalent to or wider than the width of the recording medium P.

Intermediate Transfer Belt

Examples of materials of the intermediate transfer belt 10 include known materials generally used for an intermediate belt, for example, various kinds of resins (for example, polyimide, polyamideimide, polyester, polyurethane, polyamide, polyethersulfone, fluororesins and the like), various kinds of rubbers (for example, nitrile rubber, ethylene propylene rubber, chloroprene rubber, isoprene rubber, styrene rubber, butadiene rubber, butyl rubber, chlorosulfonated polyethylene, urethane rubber, epichlorohydrin rubber, acrylic rubber, silicone rubber, fluororubber and the like), and metal materials (for example, stainless steel and the like). The intermediate transfer belt 10 may have a single layer structure or may be a multi-layer structure.

Since the stimulus supplying device 18 is arranged in the inside of the intermediate transfer belt 10 in the first exemplary embodiment as described above, a stimulus is transmitted through the intermediate transfer belt 10, and then is supplied to the curable solution layer 12B. Accordingly, the intermediate transfer belt 10 is preferably stimulus-transmissive in order to supply the stimulus to the curable solution layer 12B. Further, the intermediate transfer belt 10 has preferably a stimulation-resistance.

For example, when the stimulus supplying device 18 is an ultraviolet ray irradiating device, the intermediate transfer belt 10 is preferably a belt having an ultraviolet ray transmissivity and a durability against ultraviolet rays. Specifically, the intermediate transfer belt 10 has preferably an ultraviolet ray transmissivity of 70% or more, for example. When the ultraviolet ray transmissivity of the intermediate transfer belt 10 is in the above range, the ultraviolet radiation energy required for the curing reaction of the curable layer 12B may be effectively supplied to the curable layer 12B, while suppressing the generation of heat or the like due to the absorption of ultraviolet rays by the intermediate transfer belt 10.

Specific examples of materials for the intermediate transfer belt 10 having an ultraviolet ray transmissivity and having durability against ultraviolet rays include ETFE (ethylene-tetrafluoroethylene copolymer), a polyethylene terephthalate film, a polyimide film, and a polyolefin film.

A surface releasing layer may be formed on the surface of the intermediate transfer belt 10 where the intermediate transfer belt 10 contacts the curable solution layer 12B. Examples of materials which may be used for the surface releasing layer include fluororesins.

Among them, it is preferable to use materials having a transmissivity to the stimulus. Further, when a material having less transmissive to the stimulus is used, it is preferable that the thickness of the surface releasing layer be thinner.

The surface releasing layer may be formed on the intermediate transfer belt 10 on the surface where the intermediate transfer belt 10 contacts the curable solution layer 12B, using a surface releasing layer coating device.

The surface releasing agent coating device is arranged at the upstream side from the curable solution layer forming device 12 in the moving direction of the intermediate transfer belt 10. That is, the surface releasing agent coating device is arranged between the curable solution layer forming device 12 and the cleaning device 20 on the periphery of the intermediate transfer belt 10.

For example, the releasing agent coating device is formed by including a supply roller that supplies a releasing agent to the intermediate transfer belt 10 and a blade that regulates the thickness of the releasing agent layer formed of the supplied releasing agent, in a housing in which the releasing agent is accommodated, and, as needed, by including a heating unit that heats and fuses the releasing agent.

The releasing agent coating device may be formed such that the supply roller continuously contacts the intermediate transfer belt 10, or may be apart from the intermediate transfer belt 10. Further, the releasing agent coating device is not restricted to such a configuration, and devices using known coating methods (for example, coating using a bar coater, spray coating, inkjet coating, air knife coating, blade coating, roll coating and the like) may be applied.

Specifically, examples of the releasing agents include silicone oils, fluorine-containing oils, hydrocarbons, polyalkylene glycols, fatty acid esters, phenyl ethers, and phosphoric esters, and among these, silicone oils, fluorine-containing oils and polyalkylene glycols are desirable.

Examples of the silicone oils include straight silicone oils and modified silicone oils. Examples of the straight silicone oils include dimethyl silicone oil and methyl hydrogen silicone oil.

Examples of the modified silicone oils include methylstyryl-modified silicone oils, alkyl-modified silicone oils, higher fatty acid ester-modified silicone oils, fluorine-modified silicone oils, and amino-modified silicone oils.

Examples of the polyalkylene glycols include polyethylene glycol, polypropylene glycol, ethylene oxide-propylene oxide copolymer and polybutylene glycol, and among these, polypropylene glycol and polyethylene glycol are desirable.

Curable Solution Layer Forming Device

For example, the curable solution layer forming device 12 is formed by including a supply roller 12D that supplies a curable solution 12A to the intermediate transfer belt 10, and a blade 12E that regulates the thickness of the curable solution layer 12B formed by the supplied curable solution 12A in a housing 12C, in which the curable solution 12A is accommodated.

The curable solution layer forming device 12 may be formed such that the supply roller 12D continuously contact the intermediate transfer belt 10, or may be apart from the intermediate transfer belt 10. Further, in the curable solution layer forming device 12, the curable solution 12A may be supplied to the housing 12C from an independent solution supply system (not shown), so that the curable solution may be continuously supplied to the intermediate transfer belt 10. The curable solution 12A will be described in detail later.

The curable solution layer forming device 12 is not restricted to the above configuration, and includes devices using known coating methods (for example, coating methods such as a die coating method, a bar coating method, a spray coating method, an inkjet coating method, an air knife coating method, a blade coating method, a roll coating method or the like).

Inkjet Recording Head

An inkjet recording head 14 may include, for example, color recording heads including a recording head 14K for applying a black ink, a recording head 14C for applying a cyan ink, a recording head 14M for applying a magenta ink and a recording head 14Y for applying a yellow ink, in this order from the upstream side in the direction of the movement of the intermediate transfer belt 10. Needless to say, the configuration of the recording head 14 is not restricted to this configuration, and, for example, may be formed only from the recording head 14K, or may be formed by at least one of the recording head 14C, the recording head 14M and the recording head 14Y. Further, recording heads for other colors such as a pale color, white color or other specific colors may be added.

Each recording head 14 is arranged, for example, on an unbent region (i.e., a region in which the intermediate transfer belt 10 is not bent) of the intermediate transfer belt 10 which is rotatably supported under tension, and the distance between the surface of the intermediate transfer belt 10 and the nozzle surface of the recording head 14 is, for example, 0.7 mm to 1.5 mm.

Each recording head 14 is preferably, for example, a line type inkjet recording head having a width equivalent to or wider than the width of the recording medium P, or, for example, a conventional scan type inkjet recording head may be used.

The ink applying method by each recording head 14 is not specifically limited as long as an ink 14A can be applied, and examples of the ink applying method include methods such as a piezoelectric element drive type method or an exothermic element drive type method. The details of the ink will be described later.

Water-Absorption Controlling Liquid Supply Device

As a water-absorption controlling liquid supply device 13, for example, an inkjet recording head is used, which is arranged on an unbent region of the intermediate transfer belt 10 which is rotatably supported under tension, and the distance between the surface of the intermediate transfer belt 10 and the nozzle surface of the head is, for example, 0.5 mm to 1.5 mm.

The inkjet recording head (as the water-absorption controlling liquid supply device 13) is preferably, for example, a line type inkjet recording head having a width equivalent to or wider than the width of the recording medium P, or, for example, a conventional scan type inkjet recording head may be used.

The supply method of supplying a water-absorption controlling liquid 13A is not specifically limited as long as the water-absorption controlling liquid may be supplied by the methods such as a piezoelectric element drive method, an exothermic element drive method or the like.

Here, the water-absorption controlling liquid supply device 13 is not restricted to devices utilizing non-contact type supply methods such as an inkjet recording head, and devices using other common methods (for example, devices utilizing a die coating method, a bar coating method, a spray coating method, an air knife coating method, a blade coating method, a roll coating method and the like) may be applied.

However, when the water-absorption controlling liquid 13A is supplied from the water-absorption controlling liquid supply device 13 after an image T is formed using the inkjet recording head 14 and before the curable solution layer 12B, at which the image T is formed, is transferred to the recording medium P by a transfer device 16, the water-absorption controlling liquid supply device 13 is preferably a device using a non-contact type supply method such as an inkjet recording head or the like, from the viewpoint that the image T formed at the curable solution layer 12B is not disturbed.

The details of the water-absorption controlling liquid 13A will be described later.

Transfer Device

The constitution of the transfer device 16 is described hereinafter. Specifically, for example, the intermediate transfer belt 10 is extended between a pressure roll 16B and a support roll 10C, thereby forming an unbent region. In the unbent region of the intermediate transfer belt 10, a support 22 that supports the recording medium P is arranged on the opposite side of the intermediate transfer belt 10 from the pressure roll 16B and the support roll 10C. Further, a pressure roll 16A is arranged on the opposite side of the intermediate transfer belt 10 from the pressure roll B, and is brought into contact with the recording medium P through an opening portion (not shown) provided in the support.

That is, the curable solution layer 12B is in contact with both the intermediate transfer belt 10 and the recording medium P in the transfer region from the position (hereinafter, also referred to as a “contact starting position”) where the intermediate transfer belt 10 and the recording medium P are nipped between the pressure rolls 16A and 16B to the position (hereinafter, also referred to as a “peeling off position”) where the intermediate transfer belt 10 and the recording medium P are nipped between the support 10C and the support 22.

Stimulus Supplying Device

A stimulus supplying device 18 is arranged at the inside of the intermediate transfer belt 10, and supplies a stimulus to the curable solution layer 12B through the intermediate transfer belt 10 in the transfer region, in the state where the curable solution layer 12B is in contact with both the intermediate transfer belt 10 and the recording medium P.

The kind of the stimulus supplying device 18 is selected in accordance with the kind of curable materials contained in the curable solution 12A to be used. Specifically, when an ultraviolet curable material cured by being irradiated with ultraviolet rays is used, for example, an ultraviolet irradiating device as a stimulus applying device 18, which irradiates ultraviolet rays to the curable solution 12A (the curable solution layer 12B formed from the curable solution 12A), is used.

Further, when an electron beam curable material cured by being irradiated with an electron beam is used, an electron beam irradiation device as a stimulus applying device 18, which irradiates electron beams to the curable solution 12A (the curable solution layer 12B formed from the curable solution), is used.

Furthermore, when a thermosetting material cured by applying heat to the material is used, a heat applying device as a stimulus applying device 18, which applies heat to the curable solution 12A (the curable solution layer 12B formed from the curable solution), is used.

Here, as ultraviolet irradiating devices, for example, a metal halide lamp, a high-pressure mercury lamp, an ultra high-pressure mercury lamp, a deep ultraviolet radiation lamp, a lamp which excites a mercury lamp without an electrode from the outside using microwave, an ultraviolet laser, a xenon lamp, a UV-LED (ultraviolet light emitting diode), or the like may be used.

A desired wavelength can be selected when the UV-LED is used, and the UV-LED has a narrow wavelength distribution range; therefore, a UV-LED which can emit light with a wavelength having a high transmissivity to a material of the intermediate transfer belt 10 to be used may be easily selected and used depending on the material.

The irradiation conditions of ultraviolet rays is not specifically restricted, and may be selected in accordance with kinds of ultraviolet curable materials, the thickness of the curable solution layer 12B and the like, and when a metal halide lamp is used, an accumulated light amount is from 10 mJ/cm² to 1,000 mJ/cm², for example.

Further, examples of the electron beam irradiation devices include, for example, a scan type and a curtain type electron beam irradiation device, and the curtain type electron beam irradiation device is an device, in which thermoelectrons generated at a filament drawn out by a grid in a vacuum chamber are accelerated at once to form an electron current by a high voltage (for example, 70 kV to 300 kV), and further, pass through a window foil, and are released to the atmosphere. The wavelength of the electron beam is generally shorter than 1 nm, and the energy of the electron beam amounts to several MeV. In the invention, the electron beam having the wave number of the order of pm, and having an energy of from tens keV to hundreds keV is used.

The irradiation condition of the electron beam is not specifically limited, and may be selected in accordance with kinds of electron beam curable materials, the thickness of the curable solution layer 12B and the like, and for example, the quantity of the electron beam is at a level of from 5 kGy to 100 kGy.

As a heat applying device, for example, a halogen lamp, a ceramic heater, a nichrome wire heater, a microwave heater, an infrared ray lamp, or the like is used. Moreover, as the heat applying device, a heating device of an electromagnetic induction type device is also applicable.

Here, the heat applying conditions are not specifically limited, and may be selected in accordance with kinds of thermosetting materials, the thickness of the curable solution layer 12B and the like, and, for example, at a temperature of 200° C. for 5 minutes in the atmosphere.

Recording Medium

As the recording medium P, any of permeable media (for example, plain paper, coat paper and the like), and impermeable media (for example, art paper, resin film and the like) may be used. Examples of the recording medium P are not limited to these media, and industrial products such as semiconductor boards may be included.

Image Recording Process

Hereinafter, an image recording process using an image recording apparatus 101 according to a first exemplary embodiment is explained.

In the image recording apparatus 101 according to the first exemplary embodiment, the intermediate transfer belt 10 is driven and rotated, and first, the curable solution 12A is supplied to the surface of the intermediate transfer belt 10 from a curable solution layer forming device 12 to form a curable solution layer 12B.

Here, the thickness (average layer thickness) of the curable solution layer 12B is not specifically restricted, and, for example, is preferably in the range of from 1 μm to 100 μm or from about 1 μm to about 100 μm, and more preferably from 3 μm to 20 μm or from about 3 μm to about 20 μm.

Further, when the thickness of the curable solution layer 12B is set to a thickness such that an ink 14A does not reach the lowermost region of the curable solution layer 12B, the region where the ink 14A exists in the curable layer 12B is not exposed after the curable solution layer 12B is transferred to the recording medium P, and the region where the ink 14A does not exist in the curable layer 12B functions as a protective layer after being cured.

Next, the ink 14A is applied to the curable solution layer 12B from the inkjet recording head 14. The inkjet recording head 14 applies the ink 14A to the area where an image is to be formed in the curable layer 12B in accordance with predetermined image information.

In this case, the ink 14A is applied from the inkjet recording head 14, in an unbent region of the intermediate transfer belt 22 which is rotatably supported under tension. That is, the ink 14A is applied to the curable solution layer 12B in a state where the flexure of the surface of the belt is suppressed.

Next, a water-absorption controlling liquid 13A is supplied from the water-absorption controlling liquid supply device 13 to the curable solution layer 14B at which an image has been formed by applying the ink 14A to the solution layer 14B.

The water-absorption controlling liquid 13A may be supplied to an area where the image has been formed or an area slightly larger than the area where the image has been formed on the surface of the curable solution layer 12B (namely, the area where the ink 14A is applied or the area slightly larger than the area from the inkjet recording head 14) from the water-absorption controlling liquid supply device 13 based on an image information similarly to the inkjet recording to head 14, or may be supplied to the entire surface of the curable solution layer 12B. However, it is preferable that the water-absorption controlling liquid 13A be supplied to the entire surface of the curable solution layer 12B, in view of suppressing local occurrence of image deformation or reduction in the surface glossiness, which is caused owing to moistures remaining after the image recording.

The water-absorption controlling liquid 13A is supplied from the water-absorption controlling liquid supply device 13 to an unbent region of the intermediate transfer belt 10 which is rotatably supported under tension. That is, the water-absorption controlling liquid 13A is supplied to the curable solution layer 13B in a state where the surface of the belt is not bent.

Although the supply amount of the water-absorption controlling liquid 13A varies with the concentration of the water-absorption controlling component, for example, the supply amount may be from 0.05 mg/cm² to 2 mg/cm².

Next, the recording medium P and the intermediate transfer belt 10 are nipped and pressurized between the pressure rolls 16A and 16B of the transfer device 16. At this time, the curable solution layer 12B on the intermediate transfer belt 10 is brought into contact with the recording medium P (contact starting position). Thereafter, the state where the curable solution layer 12B is in contact with both the intermediate transfer belt 10 and the recording medium P is maintained until the curable solution layer 12B is nipped between the support roll 10C and the support 22 (peeling off position).

Here, the pressure applied to the curable solution layer 12B by the pressure rolls 16A and 16B is preferably from 0.001 MPa to 2 MPa, and more preferably in the range of from 0.001 MPa to 0.5 MPa.

Next, the curable solution layer 12B is cured by applying a stimulus through the intermediate transfer belt 10 from the stimulus supplying device 18 to the curable solution layer 12B in a state where the curable solution layer 12B comes in contact with (is in contact with) both the intermediate transfer belt 10 and the recording medium P. Specifically, the application of the stimulus starts after the curable solution layer 12B on the intermediate transfer belt 10 contacts the recording medium P (after passing through the contact starting position), and the application of the stimulus terminates before the curable solution layer 12B is peeled off from the intermediate transfer belt 10 (prior to arriving at the peeling off position).

The stimulus is supplied in amount such that the curable solution layer 12B is cured at a level that the curable solution layer 12B is easily peeled off from the intermediate transfer belt 10. Specifically, when the stimulus is ultraviolet rays, an accumulated light amount is from 10 mJ/cm² to 1,000 mJ/cm², for example.

Next, when the curable solution layer 12B is peeled off from the intermediate transfer belt 10 at the peeling off position, the curable resin layer (image layer), at which the image T formed from the ink 14A is formed, is formed on the recording medium P.

The residue of the curable solution layer 12B or foreign matter remaining on the surface of the intermediate transfer belt 10 after the curable solution layer 12B is transferred to the recording medium P are removed with the cleaning device 20, and the curable solution 12A is again supplied from the curable solution layer forming device 12 onto the intermediate transfer belt 10 to form a next curable solution layer 12B; in this way, the image recording process is repeated.

Through the above process, the image formation is performed in the image recording apparatus 101 according to the present exemplary embodiment.

In the image recording apparatus 101 according to the present exemplary embodiment as described above, the water-absorption controlling liquid 13A is supplied (namely, supply of the water-absorption controlling component) from the water-absorption controlling liquid supply device 13, after the image T is formed by using the inkjet recording head 14 and before the curable solution layer 12B, at which the image is formed, is transferred to the recording medium P by using the transfer device 16.

When a water-absorbing component that absorbs liquid components in the ink and solidifies the ink is included in the curable solution 12A in order to suppress ink bleed or dull image at the time of image transfer, the water-absorbing component is contained in a recorded product after recording of an image (namely, after the curing); therefore, when the water-absorbing component absorbs water (for example, moisture in air), phenomena such as image deformation or the like may arise resulting from the water-absorption. In particular, the phenomenon of image deformation easily occurs under high temperature and high humidity conditions (for example, 28° C. and 85% RH).

Here, the phenomenon of image deformation (hereinafter is referred to as an “image deformation”) means a phenomenon whereby an image is deformed or the boundaries among images are disturbed resulting from the absorption of water (for example, moisture in air) by the water-absorbing component with the passage of time.

In the image recording apparatus 101 according to the present exemplary embodiment, as described above, the water-absorption controlling liquid 13A is supplied from the water-absorption controlling liquid supply device 13, that is, the water-absorption controlling liquid 13A is brought into contact with the curable solution layer, and it is thought that the water-absorption controlling component permeates into the inside of the curable solution layer, and reaches the water-absorbing component contained in the curable solution layer, so that the water-absorption controlling component controls the water-absorption by the water-absorbing component.

Accordingly, in the image recording apparatus 101, the image deformation resulting from water after image formation may be suppressed.

In the image recording apparatus according to the present exemplary embodiment, the application of the ink 14A and the supply of the water-absorption controlling liquid 13A are performed on the same surface side of the curable solution layer 12B; therefore, when the supply of the water-absorption controlling liquid 13A (namely, the supply of a water-absorption controlling component) from the water-absorption controlling liquid supply device 13 is performed after the image T is formed by the inkjet recording head 14 and before the curable solution layer 12B, at which the image T is formed, is transferred onto the recording medium P, image bleed may be suppressed since the water-absorption is effected by the water-absorbing component when the ink is applied to the curable solution layer 13B from the inkjet recording head 14.

### Second Exemplary Embodiment

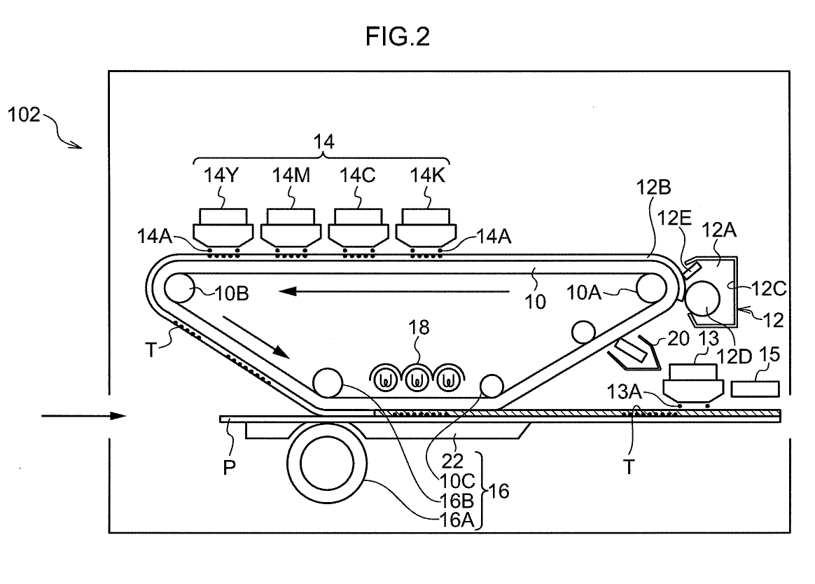

FIG. 2 is a configurational drawing showing an image recording apparatus according to a second exemplary embodiment.

An image recording apparatus 102 according to the second exemplary embodiment has a configuration substantially the same as but different from the configuration in the first exemplary embodiment in that the water-absorption controlling liquid supply device 13 is arranged to face a curable solution layer after being transferred to the recording medium P, as shown in FIG. 2.

A heating device 15 such as a heater or the like may be arranged in the image recording apparatus 102 according to the second exemplary embodiment, for example, in the conveying direction of the recording medium P at the downstream side from the water-absorption controlling liquid supply device 13, for the purpose of improving handling property of a recorded product.

Since the configurations other than the above configurations in the apparatus 102 are the same as those of the first exemplary embodiment, explanations thereof are omitted.

In the image recording apparatus 102 according to the present exemplary embodiment, the water-absorption controlling liquid 13A is supplied from the water-absorption controlling liquid supply device 13 after the curable solution layer 12B, at which an image T is formed, is transferred to the recording medium P by the transfer device 16. A water-absorption controlling component contained in the water-absorption controlling liquid 13A controls the water-absorption by the water-absorbing component contained in the curable solution layer 12B. For this reason, the image deformation caused by water after image recording (namely, after curing) is suppressed similarly to the first exemplary embodiment.

Further, in the image recording apparatus 102 according to the present exemplary embodiment, since the water-absorption controlling liquid 13A is supplied from the water-absorption controlling liquid supply device 13 to the surface of the curable solution layer 12B after being transferred to the recording medium P by the transfer device 16, namely to the surface (image surface) of the image recorded product (i.e., the surface of the curable solution layer 12B opposite to the surface to which the water-absorption controlling liquid 13A is applied in the first exemplary embodiment), it is thought that the water-absorption by the water-absorbing component existing on the surface (image surface) of the image recorded product is easily inhibited; therefore, the reduction in surface glossiness caused by water after image recording (namely, after curing) may be suppressed, as compared with the first exemplary embodiment.

Further, in the image recording apparatus 102 according to present exemplary embodiment, since the water-absorption controlling liquid 13A is supplied to the surface opposite to the surface to which the ink is applied in the curable solution layer 12B, disturbance of the image T on the surface (image surface) of the image recorded product resulting from the supply of the water-absorption controlling liquid 13A may be suppressed.

### Third Exemplary Embodiment

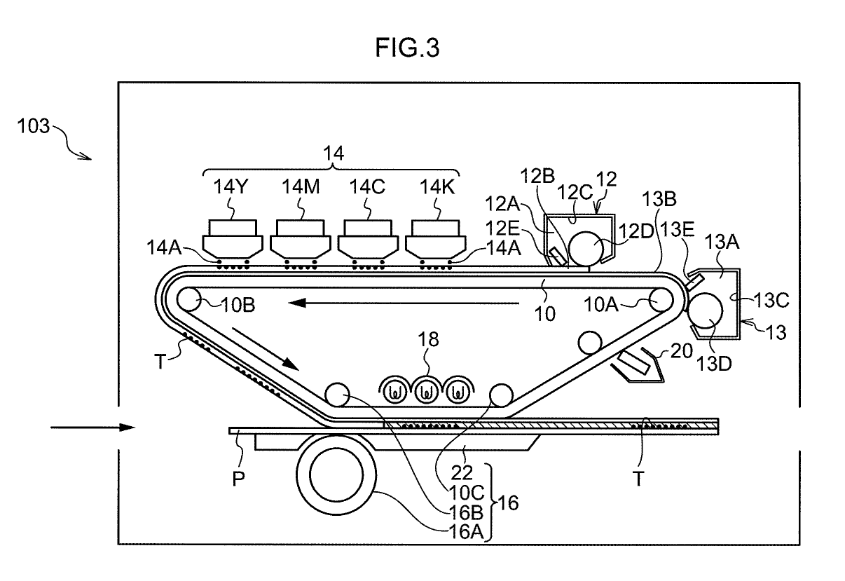

FIG. 3 is a schematic configurational drawing showing an image recording apparatus according to a third exemplary embodiment.

As shown in FIG. 3, an image recording apparatus 103 according to the third exemplary embodiment has a configuration substantially the same as but different from that in the first exemplary embodiment in that a water-absorption controlling liquid supply device 13 is arranged to face the outer peripheral surface of the intermediate transfer belt 10, at the upstream side from the curable solution layer forming device 12 in the direction of the rotation of the intermediate transfer belt 10.

The water-absorption controlling liquid supply device 13 includes, for example, a supply roller 13D that supplies a water-absorption controlling liquid 13A to the intermediate transfer belt 10, and a blade 13E that regulates the thickness of the water-absorption controlling liquid layer 13B formed by the supplied water-absorption controlling liquid 13A, in a housing 13C in which the water-absorption controlling liquid 13A is accommodated.

The water-absorption controlling liquid supply device 13 may be formed such that the supply roller 13D is always in contact with the intermediate transfer belt 10, or may be apart from the intermediate transfer belt 10. Further, the water-absorption controlling liquid 13A may be supplied to the housing 13C from an independent solution supply system (not shown) so that the supply of the water-absorption controlling liquid 13A may be continuously supplied.

Here, the water-absorption controlling liquid 13A supplied from the water-absorption controlling liquid supply device 13 may include a releasing material together with the water-absorption controlling component.

The water-absorption controlling liquid supply device 13 is not limited to the above configuration, and may be a device using an inkjet method or a known coating method (for example, a die coating method, a bar coating method, a spray coating method, an inkjet coating method, an air knife coating method, a blade coating method, a roll coating method or the like) may be used, similarly to the first exemplary embodiment.

Since the configurations other than the above configurations in the apparatus 103 are the same as those of the first exemplary embodiment, explanations thereof are omitted.

In the image recording apparatus 103 according to the present exemplary embodiment, the intermediate transfer belt 10 is driven and rotated, and first, the water-absorption controlling liquid 13A is supplied to the surface of the intermediate transfer belt 10 from the water-absorption controlling liquid supply device 13 to form a water-absorption controlling liquid layer 13B. Here, the thickness (average layer thickness) of the water-absorption controlling liquid layer 13B is not specifically restricted, and, for example, is preferably in the range of from 0.1 μm to 20 μm, and more preferably from 0.1 μm to 10 μm.

Next, a curable solution layer 12B is formed by supplying a curable solution 12A to the surface of the water-absorption controlling liquid layer 13B on the surface of the intermediate transfer belt 10 from the curable solution layer forming device 12, and processes after this process are performed in a manner similar to the processes in the first exemplary embodiment.

In the image recording apparatus 103 as described above, the water-absorption controlling liquid layer 13B is formed by supplying the water-absorption controlling liquid 13A onto the intermediate transfer belt 10 from the water-absorption controlling liquid supply device, before the curable solution layer 12B is formed by the curable solution layer forming device 12. In such a state, when the curable solution layer 12B is formed by the curable solution layer forming device 12, the curable solution layer 12B is formed on the surface of the water-absorption controlling liquid layer 13B, whereby the same state as the state where the water-absorption controlling liquid 13A is supplied to the curable solution layer 12B is made. Thus, a water-absorption controlling component contained in the water-absorption controlling liquid 13A permeates into the curable solution layer 12B, and controls the water-absorption by the water-absorbing component contained in the curable solution layer 12B. For this reason, the image deformation resulting from water after image recording (namely, after curing) is suppressed similarly to the first exemplary embodiment.

Further, in the image recording apparatus 103 according to the present exemplary embodiment, since the water-absorption controlling liquid 13A is supplied to the surface, namely the surface (image surface) of the image recorded product of the curable solution layer 12B after being transferred to the recording medium P by the transfer device 16 from the water-absorption controlling liquid supply device 13, it is thought that the water-absorption by the water-absorbing component existing on the surface (image surface) of the image recorded product is easily inhibited, so that the reduction in surface glossiness resulting from water after image recording (namely, after curing) may be suppressed, as compared with the first exemplary embodiment.

Further, in the image recording apparatus 103 according to this exemplary embodiment, the water-absorption controlling liquid 13A is supplied from the water-absorption controlling liquid supply device 13 before the ink 14A is supplied by the inkjet recording head 14 (before image recording), and the water-absorption controlling liquid 13A from the water-absorption controlling liquid supply device 13 is supplied to the surface opposite to the surface to which the ink 14A is applied in the curable solution layer 12B. Therefore, disturbance of the image T resulting from the supply of the water-absorption controlling liquid 13A may be suppressed.

### Fourth Exemplary Embodiment

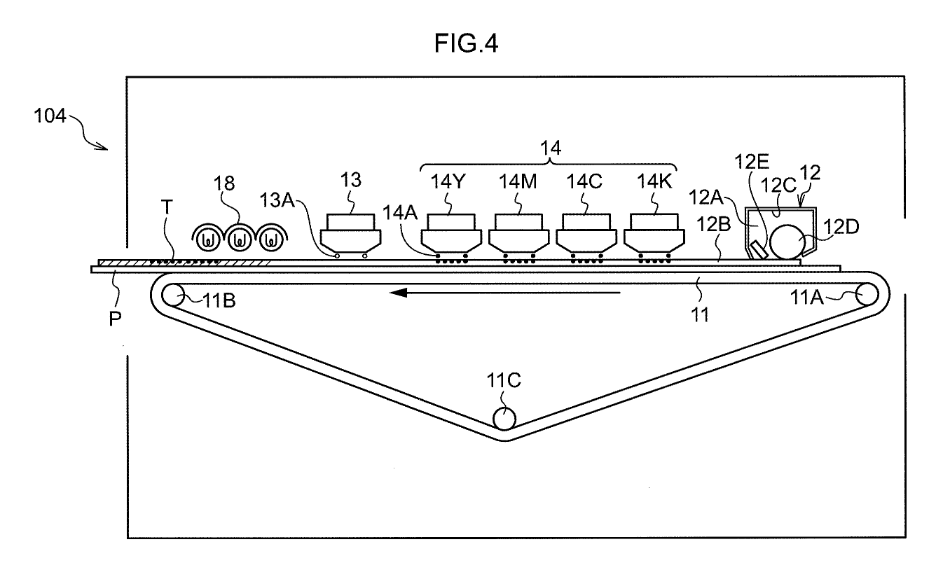

FIG. 4 is a configurational drawing showing an image recording apparatus according to a fourth exemplary embodiment.

The image recording apparatus 104 according to the fourth exemplary embodiment has a configuration in which a curable solution layer 12B is directly formed on a recording medium P that serves as a recording member, an image is formed by applying an ink 14A to the curable solution layer 12B, a liquid absorption controlling liquid 13A is supplied to the curable solution layer 12B, at which the image is formed, and the curable solution layer 12B is cured. The liquid absorption controlling liquid 13A may be supplied after curing of the curable solution layer 12B.

The image recording apparatus 104 according to this exemplary embodiment, as shown in FIG. 4, for example, is equipped with an endless-shaped recording medium conveying belt 11 (an example of a recording medium conveying unit), which is rotatably supported by three rolls 11A, 11B and 11C while applying a tensile force from the inside of the recording medium conveying belt 11. In the apparatus, from the upstream side in the direction (the arrow direction) of a recording medium P above the recording medium P conveyed by the recording medium conveying belt 11, a curable solution layer forming device 12 (an example of a curable solution layer forming unit) that supplies a curable solution 12A containing a curable material and a water-absorbing component to form a curable solution layer 12B, an inkjet recording head 14 (an example of an ink applying unit) that forms an image T by applying an ink 14A to the curable solution layer 12B, a water-absorption controlling liquid supply device 13 (an example of a water-absorption controlling component-contacting unit) that supplies a water-absorption controlling liquid 13A to the curable solution layer 12B, at which an image T is formed, and a stimulus supplying device 18 that supplies a stimulus for curing the curable solution layer 12B to which the water-absorption controlling liquid 13A is supplied, are sequentially arranged in this order.

Next, the image recording process using the image recording apparatus 104 according to the fourth exemplary embodiment is explained.

In the image recording apparatus 104 according to the fourth exemplary embodiment, the recording medium P is conveyed by driving and rotating the recording medium conveying belt 11, and the curable solution 12A is supplied from the curable solution layer forming device 12 to the surface of the recording medium P being conveyed, thereby forming a curable solution layer 12B.

Next, the ink 14A is applied to the curable solution layer 12B from the inkjet recording head 14. The inkjet recording head 14 applies the ink 14A to the area where an image is formed in the curable layer 12B in accordance with image information.

Next, a water-absorption controlling liquid 13A is supplied from the water-absorption controlling liquid supply device 13 to the curable solution layer 12B having the image therein by applying the ink 14A to the curable solution layer 12B.

Thereafter, a stimulus is supplied from a stimulus supplying device 18 to the curable solution layer 12B, whereby the curable solution layer 12B is cured.

Next, the recording medium P is removed from the recording medium conveying belt 11, so that the recording medium P, which contains a curable resin layer (image layer) containing the image T formed with the ink 14A, is obtained.

Since the configurations other than the above configurations in the apparatus 104 are the same as those of the first exemplary embodiment, explanations thereof are omitted.

In the image recording apparatus 104 according to this exemplary embodiment as described above, even if a method in which the curable solution layer 12B is directly formed on the recording medium P is used, the water-absorption controlling liquid 13A is supplied from the water-absorption controlling liquid supply device 13, that is, the water-absorption controlling liquid 13A is brought into contact with the curable solution layer, so that it is thought that a water-absorption controlling component permeates into the inside of the curable solution layer, and reaches the water-absorbing component contained in the curable solution layer, thereby controlling the water-absorption by the water-absorbing component, as described in the first exemplary embodiment.

Accordingly, in the image recording apparatus 104, the image deformation resulting from water after image formation may be suppressed.

Further, in the image recording apparatus 104 according to the present exemplary embodiment, the application of the ink 14A and the supply of the water-absorption controlling liquid 13A are performed on the same surface side of the curable solution layer 12B, and the supply of the water-absorption controlling liquid 13A (namely, the supply of a water-absorption controlling component) from the water-absorption controlling liquid supply device 13 is performed after the image T is formed using the inkjet recording head 14.

Therefore, the water-absorption is effected by the water-absorbing component, and image bleed may be suppressed, when the ink is applied to the curable solution layer 12B from the inkjet recording head 14.

Further, in the image recording apparatus 104 according to the present exemplary embodiment, since the water-absorption controlling liquid 13A is supplied from the water-absorption controlling liquid supply device 13 to the surface (image surface) of the image recorded product, it is thought that the water-absorption by the water-absorbing component existing on the surface (image surface) of the image recorded product is easily inhibited; therefore, the reduction in surface glossiness resulting from water after image recording (namely, after curing) may be suppressed, as compared with the first exemplary embodiment.

In addition, in the first to the third exemplary embodiments, as described above, although the supply of the stimulus is started after the curable solution layer 12B passes through the contact starting position, and is terminated before the curable solution layer 12B reaches the peeling off position, the invention is not limited to these embodiments.

Specifically, for example, the supply of the stimulus may be started at the time when the curable solution layer 12B passes through the contact starting position, or the supply of the stimulus may be started before the curable solution layer 12B passes through the contact starting position. Further, for example, the supply of the stimulus is terminated at the time when the curable solution layer 12B reaches the peeling off position, or the supply of the stimulus be terminated after the curable solution layer 12B passes through the peeling off position. Furthermore, during the period from the start of the supply of the stimulus to the termination of the supply of the stimulus, the supply of the stimulus may be temporarily suspended, and thereafter, may be restarted.

Moreover, in the first to the third exemplary embodiments, as described above, the stimulus supplying device 18 is arranged at the inside of the intermediate transfer belt 10, and after the stimulus is transmitted through the intermediate transfer belt 10, the stimulus is supplied to the curable solution layer 12B, but the invention is not limited to these embodiments. Specifically, for example, an embodiment, in which the stimulus supplying device 18 is arranged at the outside of the intermediate transfer belt 10, and the stimulus is directly (or after being transmitted through the support 22 and the recording medium P) supplied to the curable solution layer 12B on the intermediate transfer belt 10 without being transmitted through the intermediate transfer belt 10, may be feasible.

Moreover, for example, an embodiment, in which the stimulus transmitted though the intermediate transfer belt 10 is supplied to the curable solution layer 12B, while the stimulus supplying device 18 is arranged at the outside of the intermediate transfer belt 10, may be used. Specifically, for example, when the stimulus supplying device 18 is an ultraviolet radiation device, an embodiment, in which the main body of the ultraviolet radiation device is arranged at the outside of the intermediate transfer belt 10, the ultraviolet rays may be guided to the inside of the intermediate transfer belt 10 by using optical fibers or the like, and the curable solution layer 12B is irradiated with the ultraviolet rays after being transmitted through the intermediate transfer belt 10, may be exemplified.

Further, an intermediate transfer drum may be used in place of the intermediate transfer belt 10.

In the first to the fourth exemplary embodiments, although an ink 14A is selectively applied based on image data from the inkjet recording head 14 for black, yellow, magenta and cyan colors, respectively, to record an color image on a recording medium P, the image may be recorded by using a single color ink. Further, the record is not limited to record characters and the like on a recording medium, and may be generally applied to liquid droplet application (ejection) apparatuses and the like used for industrial purposes.

Hereinafter, the water-absorption controlling liquids 13A, the curable solution 12A, and the ink 14A used for the image recording apparatus according to the first to the fourth exemplary embodiments will be explained in detail.

Water-Absorption Controlling Liquid

The water-absorption controlling liquid contains a water-absorption controlling component and a solvent, and, if needed, may further contain other components.

The water-absorption controlling component is a component which controls the water-absorption by a water-absorbing component. Specifically, the water-absorption controlling component is defined as a material such that when the water-absorption controlling component is added to a water-containing sample obtained by immersing 5 g of the water-absorbing component in 300 g of pure water for one hour, the water content in an ink receptive component decreases.

When the water-absorbing component is a component having a polar group, it is preferable that the polarity of the polar group of the water-absorption controlling component be opposite to the polarity of the polar group of the water-absorbing component.

Specifically, although the water-absorption controlling component is selected according to the kinds of water-absorbing components, for example, when the water-absorbing component is a component (for example, a water-absorbing resin having an anionic group) having an anionic group (for example, a carboxyl group, a sulfonic acid group and the like), one selected from the group consisting of an electrolyte, a cationic compound and an acid may be used as the water-absorption controlling component.

Further, when the water-absorbing component has a component having a cationic group (for example, a water-absorbing resin having a cationic group such as polyacrylamide resin (for example, POLYDIACETONE ACRYLAMIDE (trade name; manufactured by Nippon Kasei Chemical Co., Ltd.), and the like), one selected from the group consisting of an electrolyte, an anionic compound and a base may be used as the water-absorption controlling component.

In consideration of the kinds of materials and a variety of combinations, the water-absorbing component has preferably an anionic component.

For example, when an electrolyte and a cationic compound are used as water-absorption controlling components, it is thought that an anionic group that forms a hydrophilic group of the water-absorbing component is masked by the formation of the ionic crosslinking of the anionic group of the water-absorbing component and the water-absorption controlling component, thereby reducing the water-absorptive capability.

Further, when an acid is used as a water-absorption controlling component, an anionic group of the water-absorbing component may be oxidized, and the anionic group that forms the hydrophilic group of the water-absorbing component may be hydrophobilized, thereby reducing the water-absorptive capability.

As the electrolytes, metal salts may be exemplified, for example.

Examples of the metal salts include metal salts formed by ions selected from monovalent metal ions (for example, alkali metal ions such as lithium ion, sodium ion or potassium ion) and polyvalent metal ions (aluminum ion, barium ion, calcium ion, copper ion, iron ion, magnesium ion, manganese ion, nickel ion, tin ion, titanium ion, zinc ion and the like), with acids selected from inorganic acids (for example, hydrochloric acid, bromic acid, hydroiodic acid, sulfuric acid, nitric acid, phosphoric acid and thiocyanic acid), organic carboxylic acid (for example, acetic acid, oxalic acid, lactic acid, fumaric acid, citric acid, salicylic acid, benzoic acid and the like) and organic sulfonic acid.

Specific examples of the metal salts include monovalent metal salts and polyvalent metal salts.

Examples of monovalent metal salts include lithium chloride, sodium chloride, potassium chloride, sodium bromide, potassium bromide, sodium iodide, potassium iodide, sodium sulfate, potassium nitrate, sodium acetate, potassium oxalate, sodium citrate, and potassium benzoate.

Examples of polyvalent metal salts include aluminum chloride, aluminum bromide, aluminum sulfate, aluminum nitrate, aluminum sodium sulfate, aluminum potassium sulfate, aluminum acetate, barium chloride, barium bromide, barium iodide, barium oxide, barium nitrate, barium thiocyanate, calcium chloride, calcium bromide, calcium iodide, calcium nitrite, calcium nitrate, dicalcium hydrogenphosphate, calcium thiocyanate, calcium benzoate, calcium acetate, calcium salicylate, calcium tartarate, calcium lactate, calcium fumarate, calcium citrate, copper chloride, copper bromide, copper sulfate, copper nitrate, copper acetate, iron chloride, iron bromide, iron iodide, iron sulfate, iron nitrate, iron oxalate, iron lactate, iron fumarate, iron citrate, magnesium chloride, magnesium bromide, magnesium iodide, magnesium sulfate, magnesium nitrate, magnesium acetate, magnesium lactate, manganese chloride, manganese sulfate, manganese nitrate, dimanganese hydrogenphosphate, manganese acetate, manganese salicylate, manganese benzoate, manganese lactate, nickel chloride, nickel bromide, nickel sulfate, nickel nitrate, nickel acetate, tin sulfate, titanium chloride, zinc chloride, zinc bromide, zinc sulfate, zinc nitrate, zinc thiocyanate, and zinc acetate.

Examples of cationic compounds include primary amines, secondary amines, tertiary amines and quaternary amines, and the salts thereof. Specific examples of the cationic compounds include tetraalkyl ammonium salts, alkyl amine salts, benzalkonium salts, alkyl pyridium salts, imidazolium salts and polyamines, and include, for example, isopropylamine, isobutylamine, t-butylamine, 2-ethylhexylamine, nonyl amine, dipropyl amine, diethyl amine, trimethyl amine, monomethyl amine, dimethyl amine, triethyl amine, dimethyl propylamine, ethylene diamine, propylene diamine, hexamethylene diamine, diethylene triamine, tetraethylene pentamine, diethanolamine, diethylethanolamine, triethanolamine, tetramethyl ammonium chloride, tetraethyl ammonium bromide, dihydroxyethyl stearylamine, 2-heptadecenyl-hydroxyethylimidazoline, lauryldimethyl benzylammonium chloride, cetylpyridinium chloride, stearamide methylpyridinium chloride, diallyldimethylammonium chloride polymers, diallylamine polymers, and monoallylamine polymers.

Examples of acids include organic acids and inorganic acids.

Examples of the organic acids include citric acid, glycine, glutamic acid, succinic acid, tartaric acid, phthalic acid, pyrrolidone carboxylic acid, pyrone carboxylic acid, pyrrole carboxylic acid, furancarboxylic acid, pyridinecarboxylic acid, coumaric acid, thiophene carboxylic acid and nicotinic acid, and the derivatives and the salts of these compounds.

Examples of the inorganic acids include hydrochloric acid, bromic acid, hydroiodic acid, sulfuric acid, nitric acid, phosphoric acid and thiocyanic acid.

Among them, as the water-absorption controlling component, polyvalent metal salts are preferred, and magnesium nitrate and calcium nitrate are particularly preferred.

Further, the water-absorption controlling component is selected according to the kinds of water-absorbing components, and when the water-absorbing component is sodium polyacrylate (sodium polyacrylate milled by a ball mill to the size of the number average particle diameter of 3.5 an aqueous 20% by weight magnesium nitrate solution may be exemplified.

The content of the water-absorption controlling component in the water-absorption controlling liquid may be from 1% by weight to 50% by weight, for example.

Examples of solvents include water, various alcohols such as ethanol, and various energy-curable materials.

Examples of other additional components include various surfactants, high boiling point solvents, and polymer additives.

Here, a releasing agent may be contained in the water-absorption controlling liquid 13A (in particular, in the case of the third exemplary embodiment). Examples of the releasing agent include silicone oils, modified silicone oils, fluorine-containing oils, hydrocarbon oils, mineral oils, vegetable oils, polyalkylene glycols, alkyleneglycol ethers, alkanediols, melted waxes, and surfactants.

The viscosity of the water-absorption controlling liquid 13A is preferably, for example, 5,000 mPa·s or less, and more preferably 1,000 mPa·s or less.

The viscosity is a value measured at a shear rate of 500 [l/s] by using MARS (trade name; manufactured by HAAKE GmbH) as a viscometer.

Curable Solution

Next, the curable solution 12A is explained in detail. The curable solution 12A contains at least a curable material which can be cured with an external stimulus (energy), and a water-absorbing component.

Next, the curable materials are explained.

“The curable material which can be cured with an external stimulus (energy)” means that a material is cured by an external stimulus to form a “curable resin”. Specifically, examples of the curable material include curable monomers, curable macromers, curable oligomers, and curable prepolymers.

Examples of the curable material include ultraviolet curable materials, electron beam curable materials, and thermosetting materials. The ultraviolet curable materials are easily cured, the curing velocity thereof is higher as compared with other materials, and the ultraviolet curable materials are easy to be handled; and accordingly, the ultraviolet curable materials are most desirable. The electron beam curable materials do not require a polymerization initiator, and are easy to control the coloring of a layer after curing. The thermosetting materials are curable without using a large-scale apparatus. In addition, the curable materials are not restricted thereto, and for example, materials curable with moisture, oxygen, or the like may be used. Here, the curable materials are irreversibly cured.

Examples of the “ultraviolet curable resin” obtained by curing an ultraviolet curable material include, for example, an acrylic resin, a methacrylic resin, a urethane resin, a polyester resin, a maleimide resin, an epoxy resin, an oxetane resin, a polyether resin, and a polyvinyl ether resin. The curable solution 12A contains at least one kind selected from the group consisting of an ultraviolet curable monomer, an ultraviolet curable macromer, an ultraviolet curable oligomer, and an ultraviolet curable prepolymer. Further, the curable solution 12A contains preferably an ultraviolet radiation polymerization initiator for promoting an ultraviolet curing reaction. Furthermore, the curable solution 12A may contain a reaction aid, a polymerization promoter, or the like for promoting a polymerization reaction, if necessary.

Here, examples of the ultraviolet curable monomers include, for example, radical curable materials such as acrylic esters of alcohols/polyhydric alcohols/amino alcohols, methacrylic esters of alcohols/polyhydric alcohols, acrylic aliphatic amides, acrylic alicyclic amides or acrylic aromatic amides; and cationic curable materials such as an epoxy monomer, an oxetane monomer or a vinylether monomer. Examples of the ultraviolet curable macromers, the ultraviolet curable oligomer and the ultraviolet curable prepolymer include, in addition to those prepared by polymerizing these monomers, radical curable materials such as an epoxy acrylate, a urethane acrylate, a polyester acrylate, a polyether acrylate, a urethane methacrylate or a polyester methacrylate, which is formed by adding an acryloyl group or a methacryloyl group to an epoxy, urethane, polyester or polyether skeleton.

In the case where a curing reaction proceeds through a radical reaction, examples of ultraviolet radiation polymerization initiators include a benzophenone polymerization initiator, a thioxanthone polymerization initiator, a benzyl dimethyl ketal polymerization initiator, an α-hydroxyketone polymerization initiator, an α-hydroxy alkylphenone polymerization initiator, an α-aminoketone polymerization initiator, an α-amino alkylphenone polymerization initiator, a mono-acylphosphine oxide polymerization initiator, a bisacylphosphine oxide polymerization initiator, a hydroxybenzophenone polymerization initiator, an aminobenzophenone polymerization initiator, a titanocene polymerization initiator, an oxime ester polymerization initiator, and an oxyphenyl acetate polymerization initiator.

In the case where the curing reaction proceeds through a cationic reaction, examples of the ultraviolet radiation polymerization initiators include an aryl sulfonium salt, an aryl diazonium salt, a diaryl iodonium salt, a triaryl sulfonium salt, an allene-ion complex derivative, and a triazine initiator.

Examples of the “electron beam curable resin” obtained by curing an electron beam curable material include an acrylic resin, a methacrylic resin, a urethane resin, a polyester resin, a polyether resin, and a silicone resin. The curable solution 12A contains at least one kind selected from the group consisting of an electron beam curable monomer, an electron beam curable macromer, an electron beam curable oligomer, and an electron beam curable prepolymer.

Here, examples of the electron beam curable monomer, the electron beam curable macromer, the electron beam curable oligomer, and the electron beam curable prepolymer include materials similar to the ultraviolet ray curable materials.

Examples of the “thermosetting resin” obtained by curing a thermosetting material include an epoxy resin, a polyester resin, a phenol resin, a melamine resin, a urea resin, and an alkyd resin. The curable solution 12A contains at least one kind selected from the group consisting of a thermosetting monomer, a thermosetting macromer, a thermosetting oligomer and a thermosetting prepolymer. Further, at the time of polymerization, a curing agent may be added. Furthermore, the curable solution 12A may also contain a thermal polymerization initiator for promoting the thermal curing reaction.

Here, examples of the thermosetting monomer include phenol, formaldehyde, bisphenol A, epichlorohydrin, cyanuric acid amide, urea, polyalcohols such as glycerin, and acids such as phthalic anhydride, maleic anhydride, or adipic acid. Examples of the thermosetting macromer, the thermosetting oligomer and the thermosetting prepolymer include a product obtained by polymerizing these monomers, an epoxy prepolymer, and a polyester prepolymers.

Examples of the thermal polymerization initiators include acids such as protic acid/Lewis acid, an alkali catalyst and a metal catalyst.

The curable material may be any materials as long as the material is cured with an external energy such as ultraviolet radiation, electron beam or heat (for example, curing with the progress of polymerization reaction).

Among the curable materials, in view of speeding-up the image recording, materials with a fast curing rate (for example, materials with fast polymerization reaction rate) are desirable. Examples of such curable materials include radiation curable materials (ultraviolet curable materials, electron beam curable materials, and the like).

In consideration of the wetting property of the curable material with the intermediate transfer body and the like, the curable materials may be modified with by Si, fluorine or the like. Further, in consideration of the curing rate and curing degree, the curable material contains preferably a polyfunctional prepolymer.

Further, the curable solution may contain water or an organic solvent for dissolving or dispersing the main component(s) (which is/are selected from the monomer, the macromer, the oligomer and the prepolymer, the polymerization initiator, and the like) which contributes to the curing reaction. However, the ratio of the main component (or the total ratio of the main components) is, for example, from 30% by weight or more, preferably 60% by weight, and more preferably 90% by weight or more.

Furthermore, the curable solution may contain various kinds of coloring materials for the purpose of controlling the color of the layer after being cured.

The viscosity of the curable solution is preferably from 5 mPa·s to 10,000 mPa·s, more preferably from 10 mPa·s to 1,000 mPa·s, and still from preferably from 15 mPa·s to 500 mPa·s. Further, the viscosity of the curable solution is preferably higher than the viscosity of the ink.

Next, the water-absorbing component is explained.

Examples of the water-absorbing components include a water-absorbing resin and inorganic particles (for example, silica, alumina, zeolite, and the like) processed (coated) with the water-absorbing resin.

Examples of the water-absorbing resin include a water-absorbing resin having an anionic group (such as a carboxyl group or a sulfonic acid group), and in particular, a water-absorbing resin having a carboxyl group as an anionic group is preferable.

That is, examples of the water-absorbing component include components having an anionic group (for example, a resin having an anionic group and inorganic particles processed (coated) with a water-absorbing resin having an anionic group).

Examples of the water-absorbing resins include a homopolymer of hydrophilic monomers having an anionic group, or copolymers of hydrophilic monomers and hydrophobic monomers. The polymer may be not only a polymer of monomers, and may be a graft copolymer or a block copolymer formed by copolymerizing hydrophilic units such as polymer/oligomer structures as starting units with other units.

Examples of the hydrophilic monomers include monomers including —COOM (for example, M represents a hydrogen atom, an alkali metal such as Na, Li or K, ammonia, or an organic amine) or —SO₃M (for example, M represents a hydrogen atom, an alkali metal such as Na, Li or K, ammonia, or an organic amine). Specifically, examples of the hydrophilic monomers include acrylic acid, methacrylic acid, unsaturated carboxylic acid, maleic acid, and the like. Examples of hydrophilic units include a cellulose derivative (for example, cellulose, ethyl cellulose, carboxymethyl cellulose and the like), polymerizable carboxylic acids (starch derivatives, monosaccharide-polyasccharide derivatives, vinyl sulfonic acid, styrene sulfonic acid, acrylic acid, methacrylic acid, maleic acid (anhydride), and the like), and (partial) neutral salts thereof, vinyl alcohols, and the like.

Examples of the hydrophobic monomers include monomers having a hydrophobic group, and specifically, examples of the hydrophobic monomers include olefins (such as ethylene or butadiene), styrene, a-methyl styrene, a-ethyl styrene, methyl methacrylate, ethyl methacrylate, butyl methacrylate, acrylonitrile, vinyl acetate, methyl acrylate, ethyl acrylate, butyl acrylate, and lauryl methacrylate. Examples of the hydrophobic units or monomers include styrene derivatives such as styrene, a-methyl styrene, vinyl toluene or the like; vinyl cyclohexane, vinyl naphthalene, vinyl naphthalene derivative, alkyl acrylate, phenyl acrylate, alkyl methacrylate, phenyl methacrylate, cycloalkyl methacrylate, alkyl crotonate, dialkyl itaconate, dialkyl maleate; polyolefins such as polyethylene, ethylene/vinyl acetate and polypropylene; and the derivatives of these compounds.

Preferable examples of the water-absorbing resins include polyacrylic acid and the salt thereof; polymethacrylic acid and the salt thereof; a copolymer formed from (meth)acrylic ester-(meth)acrylic acid and the salt thereof; a copolymer formed from styrene-(meth)acrylic acid and the salt thereof; a copolymer formed from styrene-(meth)acrylic ester-(meth)acrylic acid and the salt thereof; a copolymer formed from an ester formed by an alcohol having an aliphatic group or an aromatic group which has a structure of styrene-(meth)acrylic ester-carboxylic acid or the salt thereof, and (meth)acrylic acid; a copolymer formed from an ester formed by an alcohol having an aliphatic group or an aromatic group which has a structure of (meth)acrylic ester-carboxylic acid or the salt thereof, and (meth)acrylic acid; a copolymer of ethylene-(meth)acrylic acid; a copolymer formed from butadiene-(meth)acrylic ester-(meth)acrylic acid and the salt thereof; a copolymer formed from an ester formed by an alcohol having an aliphatic group or an aromatic group which has a structure of butadiene-(meth)acrylic ester-carboxylic acid or the salt thereof, and (meth)acrylic acid; polymaleic acid and the salt thereof; a copolymer formed from styrene-maleic acid and salt thereof; a sulfonic acid-modified resin of each of the above resins; and a phosphoric acid-modified resin of each of the above resins. More preferable examples of the water-absorbing resins include polyacrylic acid and the salt thereof; a copolymer formed from styrene-(meth)acrylic acid and the salt thereof; a copolymer formed from styrene-(meth)acrylic ester-(meth)acrylic acid and the salt thereof; a copolymer formed from an ester formed by an alcohol having an aliphatic group or an aromatic group which has a structure of styrene-(meth)acrylic ester-carboxylic acid and the salt thereof, and (meth)acrylic acid; and a copolymer formed from (meth)acrylic ester-(meth)acrylic acid and the salt thereof.

The water-absorbing resin may be crosslinked, or may not be crosslinked.

When the water-absorbing component has a particle-form, from the viewpoint of the compatibility of the stability of the curable resin 12A with the image quality, the water-absorbing component has preferably a volume average particle diameter of from 0.05 μm to 25 μm, and more preferably from 0.25 μm to 10 μm.

The ratio of the water-absorbing component to the whole curable solution 12A is, preferably, for example, 10% by weight or more, more preferably 20% by weight, and still more preferably in the range of from 25% by weight to 70% by weight.

Ink

Next, ink is explained in detail.

As the ink, for example, an aqueous ink containing an aqueous medium (aqueous solvent) as a solvent is used. For example, the aqueous ink may be an ink in which a water-soluble dye or water-soluble pigment as a recording material is dispersed or dissolved in the aqueous medium.

The ink is not specifically restricted, and an ink having a well-known composition is used.

Further, in particular, an ink containing, as a colorant, a dye or pigment fine particles having a particle diameter of from 10 nm to 80 nm is desirable, and when the ink is used, the colorant is easily adhered to or impregnated with a water-absorbing component, and, therefore, it is thought that the color-forming capability and the water-resistance of the colorant may be improved.

Moreover, it is preferable that an energy-curable monomer be added to an ink. When the ink is used, an image is more tightly adhered to a transfer substrate. As the energy-curable monomer, when the ink is an aqueous ink, for example, a water-soluble material with low viscosity may be used, and example of the energy-curable monomer include acryloyl morphorine and 2-hyroxypropyl acrylate.

In addition to recording materials, for example, the ink may be used for functional materials such as a liquid crystal material or an electronic material.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

### EXAMPLES

Hereinafter, the present invention will be specifically explained with reference to examples. However, the invention is not restricted to the examples.

### Example A

### Example A1

An image is recorded using the image recording apparatus according to the first exemplary embodiment as shown in FIG. 1

First, a curable solution 12A is supplied to an intermediate transfer belt 10 from a curable solution layer forming device 12, and a curable solution layer 12B is formed. Subsequently, each color ink is applied to the curable solution layer 12B from an ink jet recording head 14 (including ink jet recording heads 14K, 14C, 14M, and 14Y), and an image is formed. Next, a water-absorption controlling liquid 13A is supplied from a water-absorption controlling liquid supply device 13 to the entire surface of the curable solution layer 12B at which the image is formed. A stimulus is applied to a recording medium P from a stimulus supplying device 18 to cure the curable solution layer 12B while bringing the curable solution layer 12B into contact with the recording medium P using a transfer device 16. Thereafter, the recording medium P is peeled off from an intermediate transfer belt 10, and is evaluated. The conditions as used herein are as follows. Here, the ultraviolet irradiation intensity and accumulated light quantity described hereinafter are the ultraviolet irradiation intensity and accumulated light quantity of the ultraviolet rays after transmitted through the intermediate transfer belt 10.
Intermediate transfer belt 10: an endless belt made by polyolefin having a thickness of 0.1 mm, a width of 350 mm and an outer diameter Φ of 168 mm, and coated with a fluororesin (process speed of 200 mm/second);
Curable solution layer forming device 12: a die coater (layer thickness of curable solution layer 12B is 15 μm);
Inkjet recording head 14 for ink: a 12 inch recording test head having 14,174 nozzles/resolution 1,200 dpi (dpi: the number of dots per inch) formed by arranging 600 dpi/7,078 nozzle heads in zigzag two rows: heads for four colors (black, cyan, magenta and yellow) are arranged in parallel);
Water-absorption controlling liquid supply device 13: a 12 inch recording test head having 14,174 nozzles/resolution 1,200 dpi (dpi: the number of dots per inch)) formed by arranging 600 dpi/7,078 nozzle heads in zigzag two rows in parallel): supply amount of water-absorption controlling liquid: 0.4 mg/cm²;
Transfer device (pressure roll): a silicone roller having hardness of 20° and a diameter of 30 mm; pressing force to the intermediate transfer belt: 0.1 Mpa);
Stimulus supplying device 18: a metal halide lamp (ultraviolet irradiation intensity of 240 W/cm at an accumulated light quantity of 100 mJ/cm²);
Recording medium P: A4 size plain paper (C2: trade name; available from Fuji Xerox InterField Co., Ltd.); and
Print pattern: J6 chart (JEITA IT-3011, Standards of Printer Evaluation Pattern, March 2003, the entire disclosure of which is incorporated herein by reference).

The following curable solution, water-absorption controlling liquid and color inks are used.

Water-Absorption Controlling Liquid A1

| | |
|---|---|
| Magnesium nitrate hexahydrate: | 15% by weight |
| Ethanol: | 15% by weight |
| Ion exchange water: | 65% by weight |

Curable Solution

| | |
|---|---|
| Silicone-modified urethane acrylate: | 20 parts by weight |
| Sodium polyacrylate (water-absorbing component: water-absorbing | 25 parts by weight |
| resin having a carboxyl group, the water-absorbing resin being milled | |
| by a ball mill to the size of the number average particle diameter of 3.5 μm): | |
| Trimethylol propane ethoxytriacrylate (UV curable monomer): | 52 parts by weight |
| IRGACURE 754 (trade name; manufactured by Ciba Japan KK. | 3 pars by weight |
| (UV initiator)): | |

These compositions are mixed and a curable solution is obtained. The viscosity of the solution is 948 mPa·s.

Black ink

| | |
|---|---|
| BASACID BLACK X34 | 4% by weight |
| (trade name; manufactured by BASF Japan Ltd.): | |
| Diethylene glycol: | 10% by weight |
| Acryloyl morpholine: | 15% by weight |
| SURFINOL 465 (trade name; manufactured by | 2.0% by weight |
| Nisshin Chemical Industry Co., Ltd.): | |
| Ion exchange water: | 69% by weight |

The surface tension is 32 mN/m, and the viscosity of the ink is 3.3 mPa·s.

Cyan ink

| | |
|---|---|
| C. I. Direct Blue 199: | 4% by weight |
| Glycerin: | 20% by weight |
| Acryloyl morpholine: | 15% by weight |
| SURFINOL 465 (trade name; manufactured by | 1.5% by weight |
| Nisshin Chemical Industry Co., Ltd.): | |
| SURFINOL 440 (trade name; manufactured by | 0.3% by weight |
| Nisshin Chemical Industry Co., Ltd.): | |
| Ion exchange water: | Balance |

The surface tension is 30.1 mN/m, and the viscosity of the ink is 3.7 mPa·s.

Magenta Ink

| | |
|---|---|
| C. I. Acid Red 52: | 4% by weight |
| Diethylene glycol: | 5% by weight |
| Glycerin: | 5% by weight |
| Acetylene glycol ethyleneoxide adduct: | 1% by weight |
| 2-Hydroxypropyl acrylate: | 10% by weight |
| SURFINOL 465 (trade name; manufactured by | 1.5% by weight |
| Nisshin Chemical Industry Co., Ltd.): | |
| SURFINOL 440 (trade name; manufactured by | 0.3% by weight |
| Nisshin Chemical Industry Co., Ltd.): | |
| Ion exchange water: | 73.2% by weight |

The surface tension is 29.4 mN/m, and the viscosity of the ink is 3.2 mPa·s.

Yellow Ink

| | |
|---|---|
| C. I. Direct Yellow 132: | 4% by weight |
| Diethylene glycol: | 10% by weight |
| Glycerin: | 5% by weight |
| SURFINOL 465 (trade name; manufactured by | 2% by weight |
| Nisshin Chemical Industry Co., Ltd.): | |
| Ion exchange water: | Balance |

The surface tension is 31.2 mN/m, and the viscosity of the ink is 3.2 mPa·s.

Evaluation

Image Deformation Resulting from Water (Water-Resistance)

The image deformation resulting from water in recorded products after image recording is evaluated as follows:

Image deformation is evaluated in such a manner that after samples are allowed to stand under the conditions of 28° C. and 85% RH for 72 hours, the samples are reciprocatively rubbed ten times with BEMCOT (trade name; manufactured by Asahi Kasei Corporation).

The valuation criteria are as follows:

A: image is not substantially deformed;

B: the surface of image is slightly deformed;

C: image is partially deformed; and

D: image is deformed prior to rubbing.

Reduction in surface glossiness resulting from water (water-resistance)

The reduction in surface glossiness resulting from water in the recorded product after image recording is evaluated as follows:

The surface glossiness is evaluated in such a manner that after samples are allowed to stand under the conditions of 28° C. and 85% RH for 72 hours, the reduction in the surface glossiness of the samples is visually compared with the surface glossiness of the samples which are not allowed to stand in such conditions.

The valuation criteria are as follows:

A: reduction in surface glossiness is not observed;

B: reduction in surface glossiness is slightly observed; and

C: surface glossiness is greatly reduced.

Image Disturbance Resulting from Supply of Water-Absorption Controlling Liquid

The image disturbance resulting from supply of water-absorption controlling liquid is evaluated as follows:

Samples which are obtained when the water-absorption controlling liquid is used are compared with samples which are obtained without using the water-absorption controlling liquid in such a manner that the respective samples are observed immediately after the samples are transferred, and the degrees of image disturbance in the respective samples are evaluated by sensory evaluation.

The evaluation criteria are as follows:

A: image disturbance is not observed;

B: image disturbance is partially observed; and

C: image disturbance is observed all over the sample.

The results are shown in Table 1.

### Example A2

Image recording is performed in the same manner as in Example A1, except that the following water-absorption controlling liquid A2 is used in place of the water-absorption controlling liquid A1, and the recorded samples are evaluated.

### Water-Absorption Controlling Liquid A2

| | |
|---|---|
| Citric acid: | 7.0% by weight |
| Sodium hydroxide: | 0.6% by weight |
| Diethylene glycol: | 5% by weight |
| Acetyleneglycol ethyleneoxide adduct: | 1.0% by weight |
| Isopropyl alcohol: | 10% by weight |
| Ion exchanged water: | 71.4% by weight |

### Example A3

Image recording is performed in the same manner as in Example A1, except that the following water-absorption controlling liquid A3 is used in place of the water-absorption controlling liquid A1, and the recorded samples are evaluated.

### Water-Absorption Controlling Liquid A3

| | |
|---|---|
| Polyallyl amine (PAA-HC1-10L: trade name; | 5% by weight |
| manufactured by Nitto Boseki Co., Ltd.) | |
| Diethylene glycol: | 5% by weight |
| SURFINOL 465 (trade name; manufactured by | 1.5% by weight |
| Nisshin Chemical Industry Co., Ltd.): | |
| Ion exchanged water: | 88.5% by weight |

### Example B

### Examples B1 to B3

Image recording is performed in the same manner as in Examples A1 to A3, respectively, except that the image recording apparatus according to the second exemplary embodiment as shown in FIG. 2 is used, and the recorded samples are evaluated.

### Example C

### Examples C1 to C3

Image recording is performed in the same manner as in Examples A1 to A3, respectively, except that the image recording apparatus according to the third exemplary embodiment as shown in FIG. 3 is used, and the recorded samples are evaluated. However, as the water-absorption controlling liquid supply device 13, a gravure roll coater is used (the thickness of the water-absorption controlling liquid layer 13B is 5 μm).

### Example D

### Examples D1 to D3

Image recording is performed in the same manner as in Examples A1 to A3, respectively, except that the image recording apparatus according to the fourth exemplary embodiment as shown in FIG. 4 is used, and the recorded samples are evaluated.

### Comparative Example

Image recording is performed in the same manner as in Example A1 except that the water-absorption controlling liquid supply device 13 is not used (water-absorption controlling liquid is not supplied), and the recorded samples are evaluated.

TABLE 1

| | Image | Reduction in | Image disturbance |
|---|---|---|---|
| | deformation | surface glossiness | resulting from the supply |
| | resulting | resulting | of water-absorption |
| | from water | from water | controlling liquid |
| Example A1 | A | B | B |
| Example A2 | B | B | B |
| Example A3 | B | B | B |
| Example B1 | B | A | A |
| Example B2 | C | A | A |
| Example B3 | C | A | A |
| Example C1 | B | A | A |
| Example C2 | C | A | A |
| Example C3 | C | A | A |
| Example D1 | B | A | B |
| Example D2 | C | A | B |
| Example D3 | C | A | B |
| Comparative | D | C | — |
| Example | | | |

As shown in the above, it can been seen that the image deformation resulting from water and the reduction in surface glossiness resulting from water in Examples of the invention are suppressed as compared with those of Comparative Example.

What is claimed is:

1. An image recording apparatus comprising:
a curable solution layer forming device that forms a curable solution layer by supplying a curable solution to a recording member or an intermediate member, the curable solution including at least a curable material to be cured by an external stimulus, and a water-absorbing component;
an ink applying device that applies an ink to the curable solution layer;
a stimulus supplying device that supplies the stimulus for curing the curable solution layer, to the curable solution layer; and
a water-absorption controlling component-contact device that brings a liquid, comprising a component that controls water-absorption by the water-absorbing component, into contact with the curable solution layer, before or after the ink is applied to the curable solution layer by the ink applying device.

2. The image recording apparatus according to claim 1, wherein:
the intermediate member is an intermediate transfer body;
the curable solution layer forming device forms a curable solution layer by supplying the curable solution to the intermediate transfer body; and
the image recording apparatus further comprises a transfer device that transfers the curable solution layer from the intermediate transfer body to a recording medium by bringing the curable solution layer to which the ink is applied into contact with the recording medium.

3. The image recording apparatus according to claim 1, wherein:
the water-absorbing component has a polar group; and
the component that controls water-absorption by the water-absorbing component has a polarity opposite to a polarity of the polar group.

4. The image recording apparatus according to claim 1, wherein:
the water-absorbing component has an anionic group; and
the component that controls water-absorption by the water-absorbing component comprises at least one component selected from the group consisting of an electrolyte, a cationic compound and an acid.

5. The image recording apparatus according to claim 1, wherein:
the water-absorbing component has a cationic group; and
the component that controls water-absorption by the water-absorbing component comprises at least one component selected from the group consisting of an electrolyte, an anionic compound and a base.

6. The image recording apparatus according to claim 2, wherein:
the water-absorbing component has a polar group; and
the component that controls water-absorption by the water-absorbing component has a polarity opposite to a polarity of the polar group.

7. The image recording apparatus according to claim 2, wherein:
the water-absorbing component has an anionic group; and
the component that controls water-absorption by the water-absorbing component comprises at least one component selected from the group consisting of an electrolyte, a cationic compound and an acid.

8. The image recording apparatus according to claim 2, wherein:
the water-absorption controlling component-contact device supplies the liquid comprising a component that controls water-absorption by the water-absorbing component, to the curable solution layer, after the ink is applied to the curable solution layer by the ink applying device and before the curable solution layer is transferred from the intermediate transfer body to the recording medium by the transfer device.

9. The image recording apparatus according to claim 2, wherein:
the water-absorption controlling component-contact device supplies the liquid comprising a component that controls water-absorption by the water-absorbing component, to the curable solution layer, after the curable solution layer is transferred from the intermediate transfer body to the recording medium by the transfer device.

10. The image recording apparatus according to claim 2, wherein:
the water-absorption controlling component-contact device supplies the liquid comprising a component that controls water-absorption by the water-absorbing component, to the intermediate transfer body, before the curable solution layer is formed by the curable solution layer forming device.

11. The image recording apparatus according to claim 1, further comprising a cleaning device that removes residue of the curable solution layer remaining on a surface of the recording member or foreign matter adhered to a surface of the recording member.

12. The image recording apparatus according to claim 1, wherein the curable solution layer has an average layer thickness in the range of from about 1 μm to about 100 μm.

13. The image recording apparatus according to claim 1, wherein the curable material comprises an ultraviolet curable material, an electron beam curable material, or a thermosetting material.
